(19) United States
(12) Patent Application Publication
(10) Pub. No.: US 2026/0023624 A1
(43) Pub. Date: Jan. 22, 2026

(54) VIRTUAL MACHINE PLACEMENT WITH COORDINATION BETWEEN PLATFORM ALLOCATOR AND LOCAL HOST MANAGERS

(71) Applicant: Akamai Technologies, Inc., Cambridge, MA (US)

(72) Inventors: Jake Holland, Simi Valley, CA (US); Arun Sridharan, Cambridge, MA (US)

(21) Appl. No.: 19/172,296

(22) Filed: Apr. 7, 2025

Related U.S. Application Data
(63) Continuation-in-part of application No. 18/774,672, filed on Jul. 16, 2024.

(51) Int. Cl. G06F 9/50; G06F 11/34

(52) U.S. Cl. CPC G06F 9/5077; G06F 9/5055; G06F 11/3466

(57) ABSTRACT

Improvements in allocating virtual machines (VMs) to hosts can be accomplished using an federated approach that involves coordination between a platform allocator and local managers that are run on each host. The platform allocator can be made NUMA-aware with socket level information about current VM placement exported from the hosts by their resident local manager. Accordingly, the platform allocator can place newly requested VMs on specific sockets within hosts, attempting to optimize packing and performance. A local manager, however, may override the socket placement based on its more detailed view of subsequent local events (such as VMs being deleted or migrating away), performance data, and how the placed VMs have been using resources.

### BACKGROUND

### Technical Field

This patent document generally relates to virtualization of computing resources and to the allocation of virtual machines to hosts.

### Brief Description of the Related Art

In multitenant compute platforms, a tenant can request that the platform create a virtual machine (VM) on-demand with certain characteristics. The platform places a VM on a particular physical host in an appropriate data center. This function is sometimes referred to as allocating the VMs to hosts. Customers may choose from a variety of different VM configurations in accord with their needs and desired cost. There may be a number of configurations, with each configuration being referred to as a VM type or “plan type”. For example, a VM may be offered with 128 GB of RAM, with dedicated or with shared CPUs.

It is important to allocate VMs to physical hosts in an efficient manner because the cost of physical machines and associated networking equipment is high. It is also important to satisfy a customer's request for a new VM promptly and with a host that is not overloaded.

Known ways of allocating VMs to physical hosts involve synchronously applying a ruleset that solves for a variety of requirements and the attributes of a requested VM (its associated plan type). There may also be constraints on where to place hosts, such as geographic or data center constraints, that must be taken into account.

In known solutions, VMs are allocated by walking through the rules, selecting a set of qualifying hosts, and then continuing to narrow the selection until a placement is made. Typically the rules are heuristics. The decisions are made in a synchronous fashion, as the requests arrive. The solution may involve identifying candidate hosts with enough capacity for the requested VM plan and ordering the candidate list in a certain way to increase packing efficiency.

Typically, operators manually configure the mixture of VM types in a set of hosts, setting for example a maximum percentage of each host's memory that is allowed for a given type of VM, so as to prevent a particular VM type from overwhelming the host. For example: for a given type of host (Host_1) with a given amount of RAM, the settings might indicate that up to 50% of the host (by RAM) may allocated to VMs of type 1, which each use 64 GB memory, while up to 25% of the host may be allocated VMs of type 2, which each use 128 GB memory, and so on.

U.S. application Ser. No. 18/774,672, filed Jul. 16, 2024 (published as US Patent Publication No. 2026/______), the contents of which are hereby incorporated by reference, describes improvements in allocating virtual machines (VMs) to hosts using an approach with both an asynchronous process and a synchronous process. The asynchronous process can be executed periodically based on current VM to host allocations, current hosts, and an expected set of VM requests in the future. The asynchronous process executes optimization algorithms to create allocation data for the synchronous process. The synchronous process actually fields requests for VMs and in response makes VM placement decisions. The allocation data is a constraint on the choices available to the synchronous process. But the synchronous process can override the allocation data and place the VM on a host that is “out of plan”, so even if the plan cannot be strictly followed for a given request, it will nevertheless succeed.

It should be noted that the asynchronous process is sometimes referred to as an “offline” process or “offline” stage, while the synchronous process is sometimes referred to as an “online” process, “online” stage, or the “online allocator”.

Collectively, the processes and components described above are part of a platform-wide system that may be thought of as a “platform allocator.”. Because the platform allocator is a platform level component, it is difficult and/or expensive to have the platform allocator gather all possible information about each host's virtualized resources, resource usage and configuration, and performance. For example, this is problematic when hardware has a hardware architecture with non-uniform memory access (NUMA). In NUMA architectures, each physical CPU is associated with certain banks of RAM. This means a physical CPU can access its associated memory relatively quickly, but accessing other memory banks takes longer.

In a virtualized environment, a guest VM typically has access to a number of virtualized CPUs, or vCPUs, each of which corresponds to all or part of processing resources of a physical CPU on the motherboard. Typically, a vCPU is implemented in the hypervisor as a processing thread that may be assigned to run on a specific CPU core.

If the vCPU assignment results in a VM running on physical CPU sockets that span NUMA nodes, then vCPU threads may need to cross NUMA boundaries to access memory. Crossing NUMA boundaries incurs significant memory latency and negatively affects performance. Hence efficient placement of the VM and its vCPUs on sockets, and particularly reducing a “split” between sockets, becomes important.

The virtualized environment is informed of the underlying NUMA topology by the designation of “virtual NUMA” nodes, or “vNUMA” nodes. For example, the guest VM may be told that it has two vCPUs and one vNUMA for each vCPU, which usually means that each vCPU/vNUMA pair are on different sockets (although they could be separate vNUMA nodes on the same socket due to hardware configuration). The number of vNUMA nodes associated with a VM is determined when the VM is requested and is a function of the VM's size/plan type.

Most operating system software is “vNUMA-aware”, meaning that if it is informed about the vNUMA node assignment, it knows there are non-uniform costs for accessing memory across NUMA boundaries and therefore it must optimize its memory allocation and access accordingly. Problems occur, however, when a vNUMA node is placed across sockets or “split”. In that case, the software does not have an accurate view of the NUMA topology. Hence, it is important that split vNUMA nodes are eliminated or at least minimized.

The teachings hereof present systems, methods, and technology in which each host runs a local manager and the platform allocator coordinates with these local managers for allocation of VMs and the mitigation of negative effects caused by NUMA architectures or other host level configurations that are not exposed to the platform allocator. The teachings presented herein improve the functioning of a computer system itself, maximizing the use of its resources, while also improvising the general functioning of a cloud compute platform itself. Those skilled in the art will understand these and other improvements from the teachings hereof.

### BRIEF SUMMARY

This section describes some pertinent aspects of this invention. Those aspects are illustrative, not exhaustive, and they are not a definition of the invention. The claims of any issued patent define the scope of protection.

Described herein, among other things, are improvements allocating virtual machines (or other virtualized resources, e.g., containers) to hosts in a cloud computing platform.

Improvements in allocating virtual machines (VMs) to hosts can be accomplished using a federated approach that involves coordination between a platform allocator and local managers that are run on each host. The platform allocator can be made NUMA-aware with socket level information about current VM placement exported from the hosts by their resident local manager. Accordingly, the platform allocator can place newly requested VMs on specific sockets within hosts, attempting to optimize packing and performance. A local manager, however, may override the socket placement based on its more detailed view of the hardware it is running on, subsequent local events (such as VMs being deleted or migrating away), performance data, and how the placed VMs have been using resources.

The federated architecture has a variety of potential benefits, such as (1) simplifying the platform allocator, because it does not need to be aware of all the relevant details of the host hardware (which may vary widely across the fleet), which are instead handled by the local manager; (2) better monitoring and reaction to local host events that may affect VM allocations, as such event monitoring and handling are performed by the local manager (plus the platform allocator does not have to deal with them); and (3) reduction in the volume and frequency of host data reporting to platform allocator.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a diagram illustrating a federated model for an allocation system, in accordance with one embodiment of the teachings hereof;

FIG. 2 is a diagram illustrating an offline process for generating a plan for allocating virtual machines to hosts, in accordance with one embodiment of the teachings hereof;

FIG. 3 illustrates an example of allocation data produced by the offline process, and accordance with one embodiment of the teachings hereof;

FIG. 4 is a flow diagram illustrating generally how the offline process works, in accordance with one embodiment of the teachings hereof;

FIG. 5 is a diagram illustrating a system in which an offline process can generate allocation plans for use in online allocation; and,

FIG. 6 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION OF EMBODIMENTS

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

Basic familiarity with well-known cloud computing and networking technologies and terms, such as virtual machine (VM), hypervisor, host, random access memory (RAM), central processing unit (CPU), non uniform memory access (NUMA), VM migration techniques and so on, is assumed.

In this disclosure, the term vCPU refers to a virtualized CPU. The term “CPU” alone refers to non-virtualized CPU, e.g., not virtualized for guest VMs or workloads. That non-virtualized CPU may be an actual physical CPU or a hardware-supported CPU thread that the CPU chipset exposes to processes.

### Overview

Described herein, among other things, are improvements in allocating virtual machines (or other virtualized resources, e.g., containers) to hosts in a cloud computing platform.

The teachings hereof build upon and improve the teachings of U.S. application Ser. No. 18/774,672, filed Jul. 16, 2024 (published as US Patent Publication No. 2026/______), which are incorporated by reference in their entirety. The system described in that document, including both the asynchronous (offline) and synchronous (online) processes for allocation, is referred to herein as the “platform allocator”. As appropriate, the description below may refer to specific components within the platform allocator, such as the online process which is run by the online allocator.

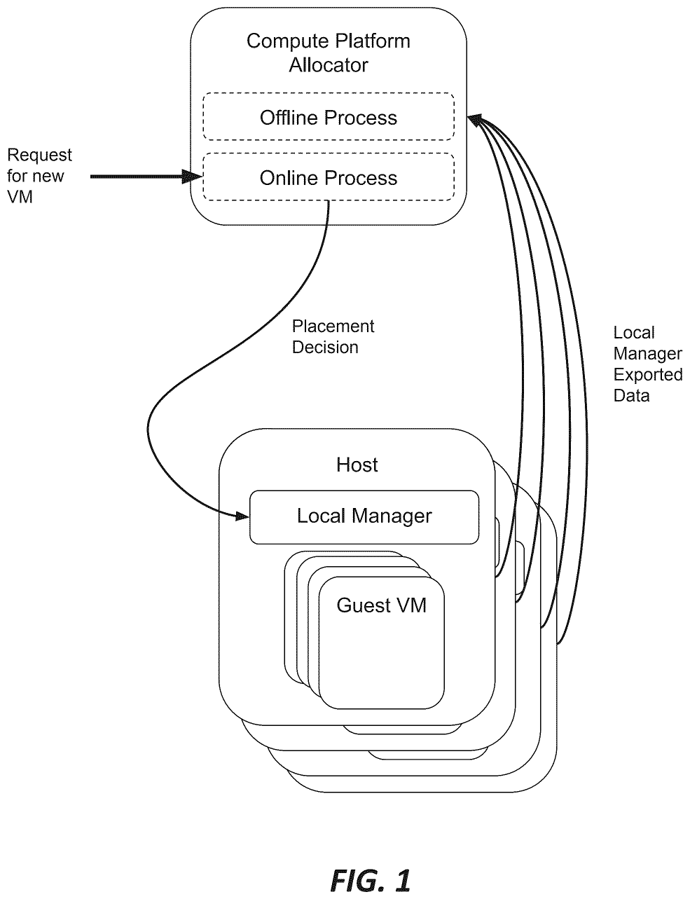

In one embodiment of the teachings hereof, a federated approach is applied to the allocation of virtual machines or other virtualized resources to hosts in a cloud computing platform that have NUMA-type hardware architectures. The following description should be read with reference to FIG. 1, which illustrates the approach at a very high level.

The platform allocator makes decisions about which host to use for a new VM, and which socket (or sockets, for a larger VM). To avoid the performance cost of a VM needing to cross NUMA boundaries when accessing memory, the platform allocation model considers not only the room available on a given host to receive a new virtual machine (e.g., in terms of free memory or other metric), but also the room on each socket on that host's hardware. The platform allocator also knows how many vNUMA nodes the requested VM has (based on plan type/size). As mentioned above, most VM operating systems are vNUMA aware. If it is not vNUMA-aware, then the VM can be treated as having a single vNUMA node regardless of plan (although this is optional).

Each host in the platform runs a local manager that can help and coordinate with the platform allocator in at least two ways. First, the local manager gathers and exports data about the current state of the host, including how the VMs are currently assigned to sockets. (As understood in the art, typically, the vCPUs of a VM will be assigned to one or more CPUs, and those CPUs are associated with a socket in the hypervisor's NUMA architecture.) The platform allocator uses this exported data in its model to develop an optimized plan for placing newly requested VMs. Second—and relevant to the federated approach—the local manager monitors host resource usage (e.g., memory) of the VMs, the performance of the VMs on the local host, as well as VM-related events (e.g., VM deletion, VM migration away from the host). While the local manager preferably honors the platform allocator's socket placement (at least initially), the local manager can modify the socket placement of a VM that was originally made by the platform allocator based on its local view. The data that the local manager uses to make these modifications is preferably retained locally, in other words not available to the platform allocator, which reduces the volume of data and the complexity of managing and incorporating such data from hosts into the platform allocator.

The above described federated approach may be implemented as a negotiation between platform allocator and local manager, where the platform allocator requests a particular placement on a particular socket, and the local manager generally accepts that request but may reject it for limited reasons (described below). After accepting it, the local manager then may modify the placement in accord with local, real-time data, based on a variety of criteria (also described below). If the local manager modifies the placement, it reports the updated allocation state to the platform allocator, enabling the platform allocator to account for such state in its next round of optimizations and/or placements. The updated allocation state may be thought of as a report on the oversubscription status of the host.

In some embodiments, the local manager has the authority to make the modification to a VM's socket placement by itself. In others, the local manager can be adapted to ask for final permission to make the modification that it has concluded is recommended. This could be a simple message exchange seeking a yes/no approval from the platform allocator, and not necessarily entail sending the underlying real-time data to the platform allocator.

Preferably, during the time period in which the local manager is making modifications to the arrangement of VMs on its host, it signals these modifications to the platform allocator. Doing so tells the platform allocator to prefer avoiding placement of new VM on that host while the modification process is ongoing, because the state of the host is in flux.

Ideally, the allocation process results in VM placements that minimize the number of vNUMA nodes that are split across sockets in the host. For example, this means that ideally single-vNUMA node VMs are placed on a single socket. And it means that ideally VMs requiring multiple vNUMA nodes are placed either on the same socket (if fitting), or with each vNUMA node on a single socket in the host.

With the foregoing by way of non-limiting overview, additional details are now provided.

### Local Manager—Data Collection

Each host in the cloud computing platform runs a process referred to as a ‘local manager’. The job of the local manager is to gather data about the host, the VMs running on it, and to communicate with the platform allocator.

The data gathered by the local manager can be separated into two categories: data that is exported to the platform allocator and data that is retained at the host. The former is sometimes referred to herein as ‘exported data’ or ‘first data’, while the latter is referred to as ‘retained data’ or ‘second data’.

The exported data can include the following:
Current VMs assigned and running on host
For each VM, memory allocation (e.g., 256 Gb plan, etc.), CPU usage
For each VM, the current socket assignment for NUMA based hardware (e.g., socket N)
Current free memory
Information about a change in the socket assignment of VM by the local manager, and a signal to recalculate the resources available in each socket of the host. This enables the platform allocator to use updated resource information per-socket for new VM assignments.
Socket assignment for a VM that is being migrated to the host.

The retained data can include the following:
Memory usage of each VM, current and past.
Performance metrics for each VM and host (e.g., CPU usage, page swaps, memory page location)
Events such as deletion, migration of VMs.
Hardware device feature sets, socket locality, and performance metrics

The volume of retained data may become quite high, particularly when considered in the aggregate over all hosts in the platform. Keeping the retained data at each host avoids problems of transporting such data across the platform. Moreover it is cumbersome and costly for the platform allocator to incorporate all of it into allocation models. Instead, as mentioned, the platform allocator assigns newly requested VMs to particular hosts and moreover to particular sockets on the hosts (pinning to a socket or to a CPU on a particular socket), however, the local managers have the ability to modify the placement decisions.

### Local Manager's Exported Data

The exported data is used by the platform allocator to make placement decisions for requested VMs.

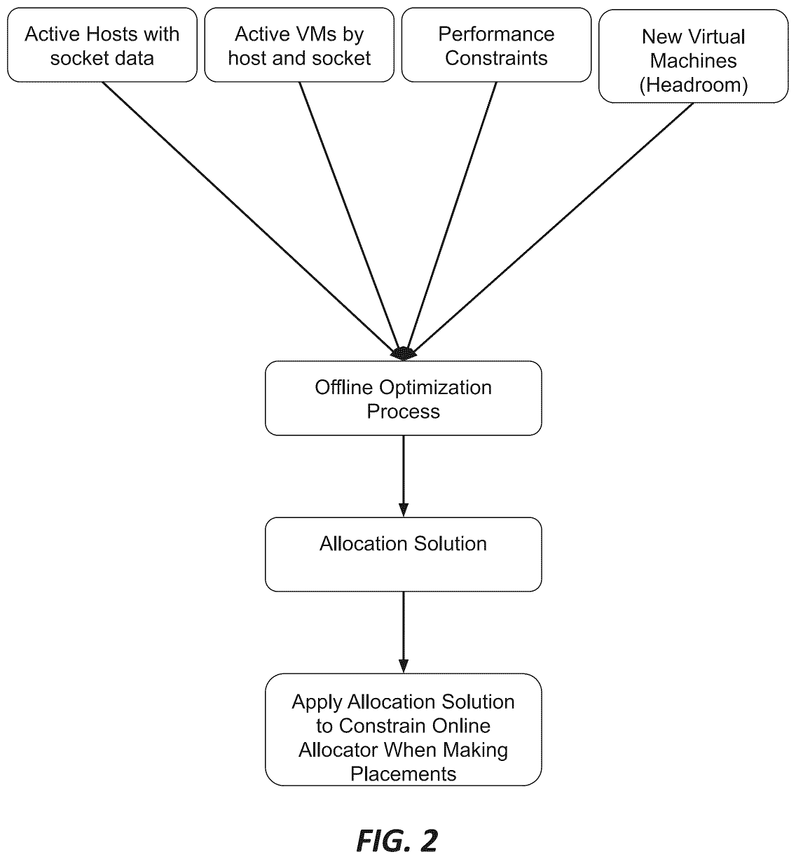

For example, FIG. 2 is a high level diagram illustrating an offline process for placing VMs in hosts.

When a user requests the creation of a new VM, the platform must pick a host in a requested data center to place it. In order to satisfy the performance requirements of the requested VM, the host needs to have sufficient free resources, which in this case means sufficient memory and also sufficient memory on a given socket.

In FIG. 2, an offline process is used to create a solution for VM allocation. It takes as input information about the active hosts, the active VMs & socket assignments, performance constraints and/or minimums, and the expected new VM requests. The information about active hosts includes such things as the capacities of each host (e.g., the amount of RAM memory, the number of CPUs, I/O characteristics, or other hardware-supported capabilities like access to GPU or VPU resources), both in terms of maximum capacity and how much is currently being used on each socket. The offline process results in a recommended allocation of host+socket for new VMs in the headroom available on the hosts, preferably keeping the current allocations static. Depending on the inputs and desired goals, the allocation solution can provide a solution that minimizes or limits the rejected VMs requests in the headroom and maximizes or increases the future availability to handle more placements (overall, or of a particular VM type), or to handle other data center events. Preferably it also minimizes the number of vNUMA nodes for VMs that are split across sockets.

In one embodiment, the offline process uses a mixed integer linear program to produce an allocation plan. As known in the art, a mixed integer linear program is a kind of optimization algorithm that provides a solution for an objective function. In this implementation, the mixed integer linear program accepts the current allocations (the active VMs and hosts) and expected new requests for each VM type. Keeping the current allocation frozen, it creates a plan for allocating new VMs into the hosts. The solution of the mixed integer linear program provides a desirable target mapping of VMs to hosts. The solution is used to direct the online allocator (the synchronous process in the platform allocator) to perform a more efficient packing. This can be accomplished by taking the solution of the mixed integer linear program and producing allocation data in the form of assigning caps to each host for each type of VM. This drives the online allocator's operation.

Subsequent to the platform allocator's offline process creating its solution, the online allocator makes the actual decisions on placement as requests arrive. It is known in the art to synchronously apply a ruleset that solves for a variety of requirements (e.g., real time status and health of hosts, etc.) and the attributes of a requested VM as well as preferences about placement on hosts (e.g. prefer host with most free memory, etc.). That is the job of the online allocator. As described in U.S. application Ser. No. 18/774,672, filed Jul. 16, 2024 (published as US Patent Publication No. 2026/______), the operation of the online allocator is modified by the solution given by the offline process. The solution is given in the form of allocation data.

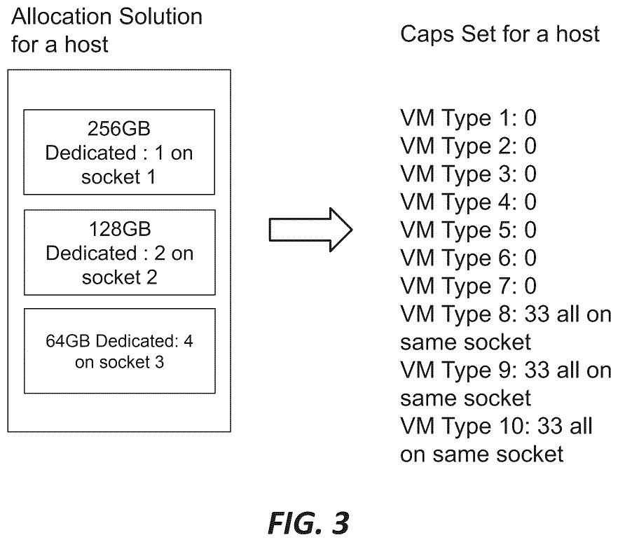

FIG. 3 illustrates an example of the allocation data produced by the offline process. On the left is a solution produced by the mixed integer linear program for one host. On the right are the caps, or limits, for that host in terms of percentages. In the example shown in FIG. 3, the solution involves allocating 4 of 64 GB dedicated on socket 3, 2 of 128 GB dedicated on socket 2 and 1 of 256 GB dedicated VMs on socket 1. Therefore, the corresponding caps for this host would be (4*64)/768=˜0.33 for VM type 8 on socket 3 (assuming, e.g., type 8 corresponds to 64 GB dedicated plans) and (2*128)/758=˜0.33 for VM type 9 on socket 2 (assuming, e.g., type 9 corresponds to 128 GB dedicated plans) and 256/758=˜0.33 for VM type 10 on socket 1 (assuming, e.g., type 10 corresponds to 256 GB dedicated plans). Of course, if there are no current plans on a host, the caps need not dictate which specific socket (id=1, 2, 3) if the sockets are fungible resource-wise. Rather, the caps indicate that all plans of a given type or given group must be on the same socket. So if the host is empty and a request for VM Type 10 arrives, the first placement might be to put the VM Type 10 on any of the sockets (since they are free); however that socket then becomes the socket for 64 Gb plans and it is unavailable for the Type 8 and 9 plans and should be filled with the other Type 10 plans.

FIG. 3 illustrates the allocation solution for one host, but in practice there are many hosts (e.g., in a data center). Each host would get its own allocation solution and own data specifying caps in a manner similar to FIG. 3, which of course may vary across hosts.

Given this solution, for a request for a VM of a given type, the online allocator can use the allocation data for each socket as a soft constraint.

For example, given the requested VM, the online allocator can first look for the hosts and sockets within hosts that have enough room within the assigned caps. If the socket has enough room, then the priority is set to 1 (meaning the host-socket has room for the slot), if not the priority is set to 0 (meaning the allocation solution did not allocate room for this VM type for the given host-socket). Ordering host-socket candidates for placing the VM by this priority number in a descending matter gives the online allocator the ability to follow the solution. When there is no host-socket with priority=1, the online allocator still has other host-socket options with priority=0, therefore the solution is not strictly enforced, it is rather a soft constraint, or a recommendation, to the online allocator.

As a second example, the online allocator does not see assigned caps. Rather the allocation data from the offline process is in the form of an ordered priority list for each type of VM. When the given request is received, the online allocator simply walks down the list for that type of VM, placing it in the first host-socket that has room. The host-sockets that are not preferred by the allocation solution are listed at the bottom of the list. So if the online allocator reaches those hosts-socket it may place the requested VM in one of them.

A third example involves the offline process specifying which hosts-sockets are subject to the allocation plan, and which are not. The online allocator receives a request for a given type of VM, and it first tries to fit the VM into host-sockets in accord with their plan, including socket requirements, but if they do not have room, the online allocator can move to the “pool” of hosts that can be filled regardless of the plan. In this approach, there is a set of hosts that are packed in accord with a plan, and a set of “overflow” hosts that the online allocator can use as needed, if they have capacity.

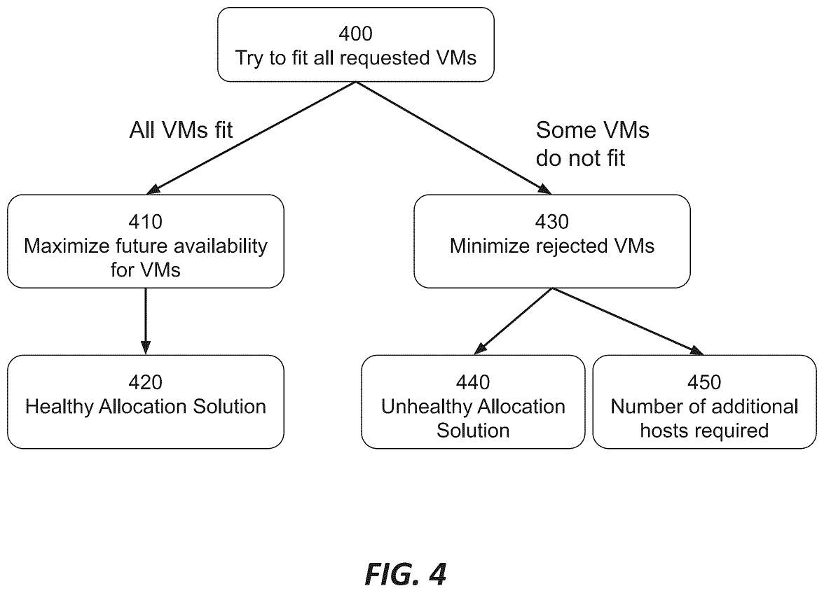

FIG. 4 illustrates at a general level how the offline process works in one embodiment. At 400, the process attempts to fit all requested VMs into the hosts (that is, the VMs that are expected to be requested in the time period for which the solution is valid). As mentioned, this packing is subject to host resources, socket constraints, performance constraints such as CPU oversubscription, the number of VMs on a given host, and the like). If all the VMs can fit, then at 410 the process attempts to increase or maximize the future availability for VMs. This analysis can take into account the VM types (e.g. a certain type of VM may be preferred because it is more popular, a new customer might be expected to use it heavily, the revenue associated with the VM type is desirable, etc.). Then at 420, the allocation solution is produced with a healthy headroom.

If some of the VMs will not fit into the hosts or violate socket constraints, then at 430 the process attempts to reduce or minimize the rejected VMs. This analysis can take into account factors such as customer, number of rejected VMs, revenue or type of VMs, and so on. Then at 440 the allocation solution is produced, but it is considered unhealthy because there were rejected VMs. So at the same time, at 450 the process produces an alert, message, or recommendation for an additional number of hosts that should be added to the data center.

An additional requirement (constraint) is that all of the virtual CPUs of a customer's VM fit into a single socket (physical CPU socket) in a multi-CPU computer, if the customer's VM is configured for a single vNUMA node or when the VM is not configured for vNUMA. Generalizing, any resource constraint that could be enforced in an online allocator can also be incorporated as a constraint in the offline process' calculation of its allocation solution.

As mentioned, the offline process can leverage an optimization algorithm in the form of a mixed integer linear program, which is executed to mathematically optimize an objective function. One example of an objective function is as follows:

$${min}_{V ( {h}_{i} , {s}_{i} )} N \times ( {\sum }_{{s}_{i} ∈ S} P ( {s}_{i} ) \cdot {Cs}_{i} ) - {\sum }_{{h}_{i} ∈ H} {\sum }_{{s}_{i} ∈ {S}_{A}} A ( {h}_{i} , {s}_{i} ) \cdot {Cs}_{i} \cdot {Ws}_{i}$$

where V(hᵢ, sᵢ) is the headroom assignment of service sᵢ to host-socket hᵢ
   Csᵢ is the revenue from service sᵢ
   Ahᵢ, is the availability of service sᵢ in host-socket hᵢ
   P(sᵢ) is the unmet headroom for service sᵢ
   Wsᵢ is the weight assigned to service sᵢ
   N is a constant that is sufficiently large such that the left side (positive side) of the function is substantially larger than the right side (negative side); for example N=10,000.

It should be noted that the solution produced by the offline process can be used to provide several different capabilities. It can provide the ability to fit new VMs given a state of the data center, the ability to prioritize the availability of certain VM types, and/or the ability to plan and constrain allocations in view of future performance requirements. It also is possible to run the offline process and its model independently for each data center. Typically the model would be expected to run, e.g., 1-5 seconds for small or medium data centers, possibly 10-30 seconds for large data centers. The model can be run periodically, e.g., every hour, to produce an updated allocation solution for the next time period. Hence the allocation solution is valid for a limited time period, after which it is rerun with updated information such as the current state of the hosts, a new set of expected requests taking into account the requests from the past hours, and so on.

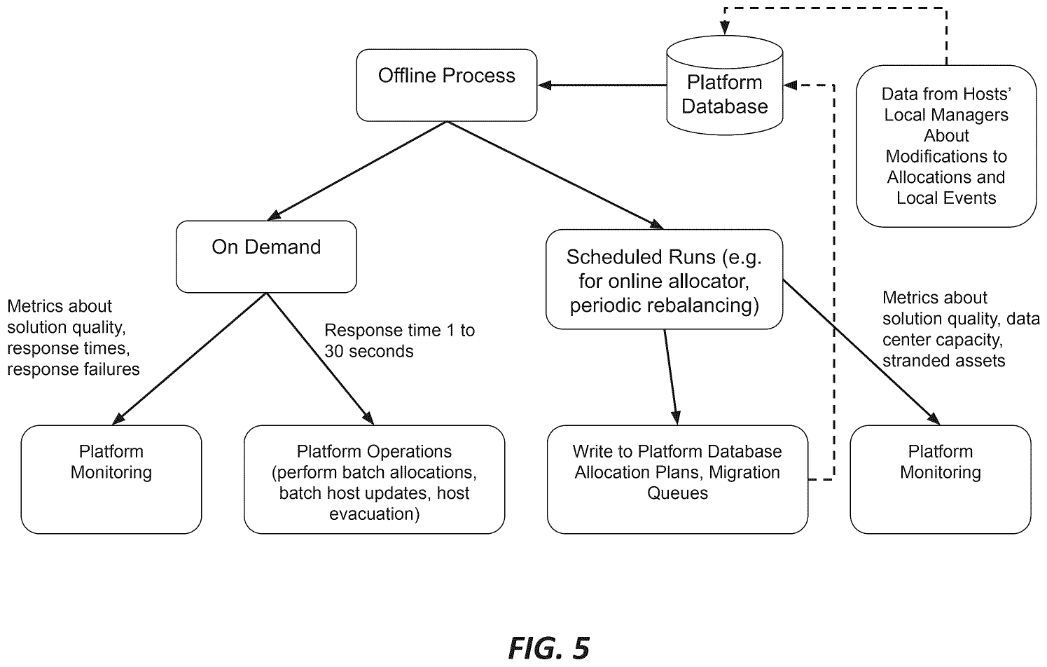

FIG. 5 illustrates a system for using the offline process' ability to allocate VMs to hosts. The results can be used on demand for platform operations (batch allocations, batch host updates, etc. migrations) as shown on the left hand side. The offline process can also be used in a scheduled run mode, e.g., to improve the online allocator operation, to perform periodic rebalancing. The platform database contains the current VM, host and socket data, including the current allocations. After a scheduled run, the offline process solutions are written back to the platform database.

The online allocator, for example, can read the allocation data from this database to understand the caps to use when it is making placement decisions. Other tools and utilities (including e.g., the platform operations shown in FIG. 5) also consult this database to understand what migration jobs must be performed, for example.

The offline process can be deployed as an optimization service. It can be built with a traditional API backed with multiple instances and load balancing. It can be built using kubernetes or other containerized technologies.

The model that the offline process optimizes and executes can be designed to run independently for each data center. Hence each datacenter in a larger platform can have its own process running with a view (inputs) specific to that datacenter and producing a solution tailored to that datacenter as well.

### Local Manager-Acceptance/Rejection of VM Placements

The local manager has the ability to accept or reject VM placements made by the platform allocator. Generally, the local manager accepts new placements of VMs and assigns them to the socket specified by the platform allocator. However, the local manager may reject a new placement from the platform allocator if doing so would cause the host to violate any of a set of requirements that would result in an unacceptable error condition if violated. An example set of requirements could include the following conditions:
(a) If the incoming VM is associated with a dedicated resource plan or specialized hardware (GPU) plan, the host has enough CPU and GPUs to assign to satisfy the customer's plan (and existing plans).
(b) Resources that are promised as dedicated (e.g. dedicated CPUs) do not overlap with other dedicated resources, or a shared or otherwise reserved pool of resources.
(c) CPUs that are simultaneous multi-threading siblings are assigned together for dedicated assignments.
(d) GPU plan vCPU threads are pinned local to their assigned GPUs

New placements come from the online allocator as new VMs are requested. If a new VM placement will violate, or cause the host to violate, any of the above criteria, then the local manager messages the online allocator that the job has been rejected, causing the online allocator to attempt to place the VM somewhere else. Preferably, the local manager reports these error conditions via platform monitoring metrics to enable platform operations teams to understand and triage the errors and for platform developer teams to troubleshoot and correct.

Generalizing, if the placement of the new VM will violate resource guarantees, platform safety limits, or hard commitments to tenants on the system, then the local manager may reject the new placement.

### Local Manager—Modification of VM Placements

The local manager also has the ability to modify accepted VM placements made by the platform allocator, under certain conditions.

Generally speaking, modifying the VM placements means moving a VM from the initially assigned socket to another socket on the same host. Oftentimes the initial placements made by the platform allocator are honored (at least for some time period or until certain events occur like VM deletion on the host). Afterwards, the modifications will be as a result of monitoring the host and the placed VMs and observing events or performance subsequent to the placement. As mentioned earlier, the local manager retains certain pieces of information locally at the host (retained data/second data) and uses these to make the decisions.

The local manager reports any modifications that it makes as well as local events (such as moving a VM to another socket, changing the destination of VM that is migrating from another host or deleting a VM) to the platform database, so that the global allocator has an updated view of state.

There may be a number of different categories of conditions that cause the local manager to modify VM placements. For example, the local manager has a set of requirements that it seeks to meet but that are not cause to reject a new placement. These are sometimes referred to as firm requirements. For example, the local manager seeks to ensure that vCPU threads that appear to the guest VM as being the same vNUMA node are pinned to CPUs that are in the same socket. (Put another way, a single vNUMA node should not be split across sockets, because that will mislead the guest VM.) This may be impossible to meet for all VMs placed on a host, or for a newly placed VM. However, if it is possible to modify the VM placements to meet this firm requirement, the local manager does so.

Typically, when the local manager decides to move a VM to a new socket, it puts that job into a migration queue. The local manager can then update the assigned socket of the migrating VM so that the online allocator can account for the socket resources of the host correctly.

Also, during the time that the local manager is moving VMs on a host, the local manager can raise a signal to the online allocator. The signal indicates that the online allocator should pause new placements to that host until the migrations are complete and the new state of the host is reported up.

It should be noted that when migrating VMs, the socket placement (that is, single socket, split) should be honored because the VM configuration with respect to NUMA nodes won't change.

Another example of a firm requirement is that the vCPU threads assigned within a socket are also pinned together with CPUs in the same NUMA node, when the hardware (BIOS) configured number of nodes per socket (NPS) is greater than 1.

In addition to firm requirements, the local manager also has a set of soft requirements that it applies. Soft requirements can be applied according to a priority list, such that a lower priority requirement is ignored if necessary to satisfy a higher priority requirement.

Examples of ranked requirements are as follows, in priority order:
1) Do not oversubscribe CPUs or memory on a socket. If impossible, balance the RAM oversubscription.
2) Satisfy the placement request for socket placement (use the socket designated by the platform allocator).
3) Avoid changing the CPU-pinning for a VM while it's running.

In addition, when making a modification to a VM, the system uses a heuristics-based scoring approach that scores various potential modifications to the VM allocation and then chooses the best scoring option. Put another way, when the local manager decides to move a VM, the local manager minimizes harm choosing the best overall candidate given the following weighted preferences:
1) Prefer moving shared VMs rather than moving dedicated VMs
2) Prefer moving less-active VMs rather than moving more-active VMs
3) Prefer moving VMs with fewer memory pages loaded on the socket it's moving away from
4) Prefer to avoid moving the same VM repeatedly (e.g. use a soft hold-down for some period with an LRU preference order for VMs that must be moved in the soft hold-down)
5) Prefer to minimize the total number of vCPU threads that must be moved when choosing between different placement change options.

The above-described VM placement modifications were initiated by the local manager. In some implementations, the local manager may accept on-demand requests for VM modifications initiated by the platform allocator. This means that the local manager for a host may receive an instruction from the allocator to modify VM placements in a certain way so as to make room for anticipated demand anticipated by the platform allocator. For example, the allocator may forecast or be given information indicating that VMs of a certain size or type will soon be requested. The platform allocator can find room for those size or type of VMs in the fleet.

### Extension Beyond VMs

While the foregoing description has used VMs as an illustrative example, the teachings hereof apply likewise to the placement or allocation of any compute resource or instance across physical hosts.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, extended, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

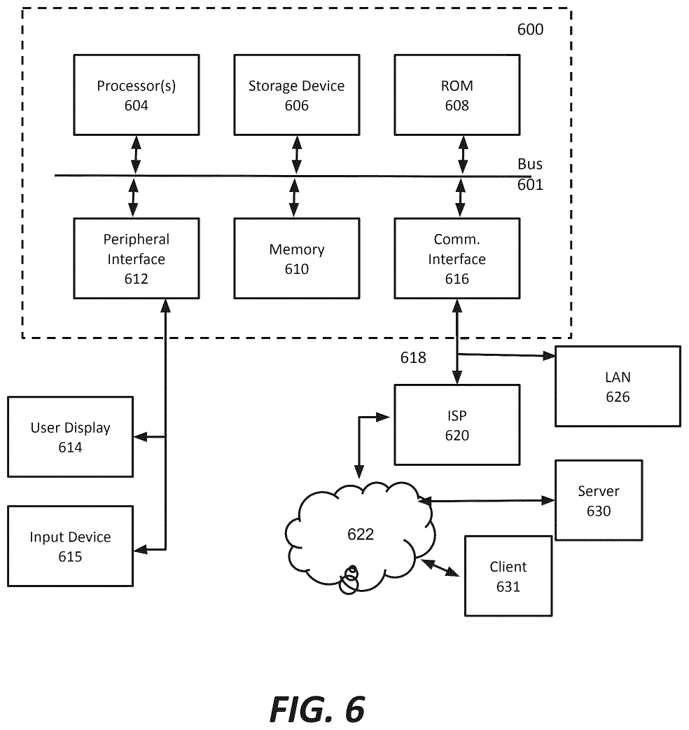

FIG. 6 is a block diagram that illustrates hardware in a computer system 600 upon which such software may run in order to implement embodiments of the invention. The computer system 600 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 600 includes a microprocessor 604 coupled to bus 601. In some systems, multiple processor and/or processor cores may be employed. Computer system 600 further includes a main memory 610, such as a random access memory (RAM) or other storage device, coupled to the bus 601 for storing information and instructions to be executed by processor 604. A read only memory (ROM) 608 is coupled to the bus 601 for storing information and instructions for processor 604. A non-volatile storage device 606, such as a magnetic disk, solid state memory (e.g., flash memory), or optical disk, is provided and coupled to bus 601 for storing information and instructions. Other application-specific integrated circuits (ASICs), field programmable gate arrays (FPGAs) or circuitry may be included in the computer system 600 to perform functions described herein.

A peripheral interface 612 may be provided to communicatively couple computer system 600 to a user display 614 that displays the output of software executing on the computer system, and an input device 615 (e.g., a keyboard, mouse, trackpad, touchscreen) that communicates user input and instructions to the computer system 600. However, in many embodiments, a computer system 600 may not have a user interface beyond a network port, e.g., in the case of a server in a rack. The peripheral interface 612 may include interface circuitry, control and/or level-shifting logic for local buses such as RS-485, Universal Serial Bus (USB), IEEE 1394, or other communication links.

Computer system 600 is coupled to a communication interface 616 that provides a link (e.g., at a physical layer, data link layer,) between the system bus 601 and an external communication link. The communication interface 616 provides a network link 618. The communication interface 616 may represent an Ethernet or other network interface card (NIC), a wireless interface, modem, an optical interface, or other kind of input/output interface.

Network link 618 provides data communication through one or more networks to other devices. Such devices include other computer systems that are part of a local area network (LAN) 626. Furthermore, the network link 618 provides a link, via an internet service provider (ISP) 620, to the Internet 622. In turn, the Internet 622 may provide a link to other computing systems such as a remote server 630 and/or a remote client 631. Network link 618 and such networks may transmit data using packet-switched, circuit-switched, or other data-transmission approaches.

In operation, the computer system 600 may implement the functionality described herein as a result of the processor executing code. Such code may be read from or stored on a non-transitory computer-readable medium, such as memory 610, ROM 608, or storage device 606. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 618 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A system for allocating virtual resources to hosts in a cloud computing platform that has a plurality of hosts in at least one data center, the system comprising at least one computer executing program code on at least one hardware processor to provide:
a platform component that executes an algorithm to choose which one of the plurality of hosts, and which socket in the chosen host, on which to place user requested virtual resources;
the algorithm comprising a function of first data exported from the each of the plurality of hosts to the platform component, the first data for each host comprising current placements of user requested virtual resources on sockets in the respective host;
a local manager running on each of the plurality of hosts, each of the local managers being aware of the platform component's socket placements on the local manager's respective host; and,
each of the local managers modifying socket placements made by the platform component on the local manager's respective host based on second data retained exclusively by the local manager and derived from monitoring on that local manager's respective host.

2. The system of claim 1, where at least one of the local managers is operable to make modifications due to an event that moves, deletes, or changes an allocated size of a virtual machine.

3. The system of claim 1, where at least one of the local managers is operable to modify a socket placement to remedy a virtual NUMA node that is split across two or more sockets.

4. The system of claim 1, where the second data for at least one of the local managers comprises data derived from monitoring of any of: (i) memory activity of virtual resources running on the at least one local manager's host, and (ii) performance measurements of virtual resources running on the at least one local manager's host.

5. The system of claim 1, wherein the user requested virtual resources comprise virtual machines (VMs).

6. The system of claim 1, wherein the platform component is NUMA-aware.

7. The system of claim 1, wherein the local manager is operable to raise a signal to the platform component indicating that a modification to socket placements is occurring.

8. A method for allocating virtual machines among a plurality of hosts in a cloud computing platform, the method performed by at least one computer and comprising:
with a platform component, executing an algorithm to choose which one of the plurality of hosts, and which socket in the chosen host, on which to place user requested virtual resources;
the algorithm comprising a function of first data exported from the each of the plurality of hosts to the platform component, the first data for each host comprising current placements of user requested virtual resources on sockets in the respective host;
running a local manager on each of the plurality of hosts, each of the local managers being aware of the platform component's socket placements on the local manager's respective host; and,
each of the local managers modifying socket placements made by the platform component on the local manager's respective host based on second data retained exclusively by the local manager and derived from monitoring on that local manager's respective host.

9. The method of claim 8, further comprising: at least one of the local managers makes modifications due to an event that moves, deletes, or changes an allocated size of a virtual machine.

10. The method of claim 8, further comprising: at least one of the local managers modifies a socket placement to remedy a virtual NUMA node that is split across two or more sockets.

11. The method of claim 8, where the second data for at least one of the local managers comprises data derived from monitoring of any of: (i) memory activity of virtual resources running on the at least one local manager's host, and (ii) performance measurements of virtual resources running on the at least one local manager's host.

12. The method of claim 8, wherein the user requested virtual resources comprise virtual machines (VMs).

13. The method of claim 8, wherein the platform component is NUMA-aware.

14. The method of claim 8, wherein the local manager raises a signal to the platform component indicating that a modification to socket placements is occurring.

15. Non-transitory computer readable medium comprising program code for execution one at least one hardware processor to cause at least one computer to perform steps for allocating virtual machines to hosts in a cloud computing platform, the steps comprising:
with a platform component, executing an algorithm to choose which one of the plurality of hosts, and which socket in the chosen host, on which to place user requested virtual resources;
the algorithm comprising a function of first data exported from the each of the plurality of hosts to the platform component, the first data for each host comprising current placements of user requested virtual resources on sockets in the respective host;
running a local manager on each of the plurality of hosts, each of the local managers being aware of the platform component's socket placements on the local manager's respective host; and,
each of the local managers modifying socket placements made by the platform component on the local manager's respective host based on second data retained exclusively by the local manager and derived from monitoring on that local manager's respective host.
